(19) United States
(12) Patent Application Publication
(10) Pub. No.: US 2016/0191609 A1
(43) Pub. Date: Jun. 30, 2016

(54) METHOD AND APPARATUS FOR PROVIDING PLAYLIST IN NETWORK

(71) Applicant: Samsung Electronics Co., Ltd., Suwon-si (KR)

(72) Inventor: Jicheol MOON, Seoul (KR)

(21) Appl. No.: 14/980,823

(22) Filed: Dec. 28, 2015

(30) Foreign Application Priority Data
Dec. 31, 2014 (KR) 10-2014-0195345

(51) Int. Cl. H04L 29/08; H04L 12/26

(52) U.S. Cl. CPC H04L 67/06; H04L 43/0882

(57) ABSTRACT

An apparatus, a terminal, and a method for providing a playlist are provided. The apparatus includes a communication unit configured to perform communication with another network entity and a control unit configured to receive a playback request message for content from a terminal through the communication unit, transmit a request for a playlist including information of at least one bandwidth capable of playing the content to a server, receive the playlist from the server through the communication unit, revise the received playlist based on information of an available network bandwidth, and transmit the revised playlist to the terminal through the communication unit.

### CROSS-REFERENCE TO RELATED APPLICATION(S)

This application claims the benefit under 35 U.S.C. §119(a) of a Korean patent application filed on Dec. 31, 2014 in the Korean Intellectual Property Office and assigned Serial number 10-2014-0195345, the entire disclosure of which is hereby incorporated by reference.

### TECHNICAL FIELD

The present disclosure relates to technique to provide a playlist. More particularly, the present disclosure relates to a method and apparatus for providing a playlist revised depending on an available bandwidth of a network.

### BACKGROUND

With network technologies advanced today, a terminal can offer a great variety of multimedia contents to a user by means of interworking with a content server in a network. Namely, the user can access the content server through the terminal regardless of time and then download, or display in real-time streaming, desired multimedia content.

For example, using the terminal, the user can use a video-on-demand (VOD) service, which includes in general a video clip download service, a real-time broadcast service, a service linked to a messaging service, and the like.

When the user uses certain multimedia content, the content server may offer various services based on different image qualities and/or different sound qualities for that content.

However, in case there are numerous users in the network, this may often cause an insufficient bandwidth of the network. In such case, some services may be not offered smoothly.

Accordingly, needed is a method for providing a playlist which allows smooth services for a terminal on the basis of information about an available bandwidth of a network.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a technique to receive information about an available bandwidth of a network, revise a playlist depending on the available bandwidth of the network, and provide the revised playlist to a terminal.

In accordance with an aspect of the present disclosure, an apparatus for providing a playlist is provided. The apparatus includes a communication unit configured to perform communication with another network entity, and a control unit configured to receive a playback request message for content from a terminal through the communication unit, transmit a request for a playlist including information of at least one bandwidth capable of playing the content to a server through the communication unit, receive the playlist from the server through the communication unit, revise the received playlist based on information of an available network bandwidth, and transmit the revised playlist to the terminal through the communication unit.

In accordance with another aspect of the present disclosure, a terminal for receiving a playlist is provided. The terminal includes a communication unit configured to perform communication with another network entity, and a control unit configured to control the communication unit to transmit a playback request message for content to a playlist providing apparatus, and control the communication unit to receive a revised playlist from the playlist providing apparatus. The revised playlist is based on a playlist including information of at least one bandwidth capable of playing the content, according to information of an available network bandwidth.

In accordance with yet another aspect of the present disclosure, a method for providing a playlist at a playlist providing apparatus in a network is provided. The method includes receiving, from a terminal, a playback request message for content, transmitting, to a server, a request for a playlist including information of at least one bandwidth capable of playing the content, receiving, from the server, the playlist, revising, based on information of an available network bandwidth, the received playlist, and transmitting, to the terminal, the revised playlist.

In accordance with still another aspect of the present disclosure, a method for receiving a playlist at a terminal in a network is provided. The method includes transmitting a playback request message for content to a playlist providing apparatus, and receiving a revised playlist from the playlist providing apparatus. The revised playlist is based on a playlist including information of at least one bandwidth capable of playing the content, according to information of an available network bandwidth.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an internal structure of a playlist providing apparatus according to an embodiment of the present disclosure;

FIG. 2 is a block diagram illustrating an internal structure of a terminal according to an embodiment of the present disclosure;

FIG. 3 is a diagram illustrating a method for providing contents to a terminal through a content server according to an embodiment of the present disclosure;

FIG. 4 is a diagram illustrating a method for providing contents to a terminal through a playlist providing apparatus according to an embodiment of the present disclosure;

FIG. 5 is a flow diagram illustrating a method for providing contents to a terminal through a playlist providing apparatus according to an embodiment of the present disclosure;

FIG. 6 is a diagram illustrating a detailed method for providing contents to a terminal through a playlist providing apparatus according to an embodiment of the present disclosure;

FIG. 7 is a diagram illustrating a method for providing contents to a terminal through a playlist providing apparatus according to an embodiment of the present disclosure; and

FIG. 8 is a diagram illustrating a method for providing contents to a terminal through a playlist providing apparatus according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present disclosure. Although the drawings represent various embodiments, the drawings are not necessarily to scale and certain features may be exaggerated or omitted in order to better illustrate and explain the present disclosure. Through the drawings, the same or similar reference numerals denote corresponding features consistently.

Unless defined differently, all terms used herein, which include technical terminologies or scientific terminologies, have the same meaning as that understood by a person skilled in the art to which the present disclosure belongs.

The terms such as “comprise”, “include”, and/or “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof The expression “or” includes any and all combinations of the associated listed words. For example, the expression “A or B” may include A, may include B, or may include both A and B.

In various embodiments disclosed herein, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them the first user device and the second user device are user devices. For example, a first element could be termed a second element, and similarly, a second element could be also termed a first element without departing from the scope of the present disclosure.

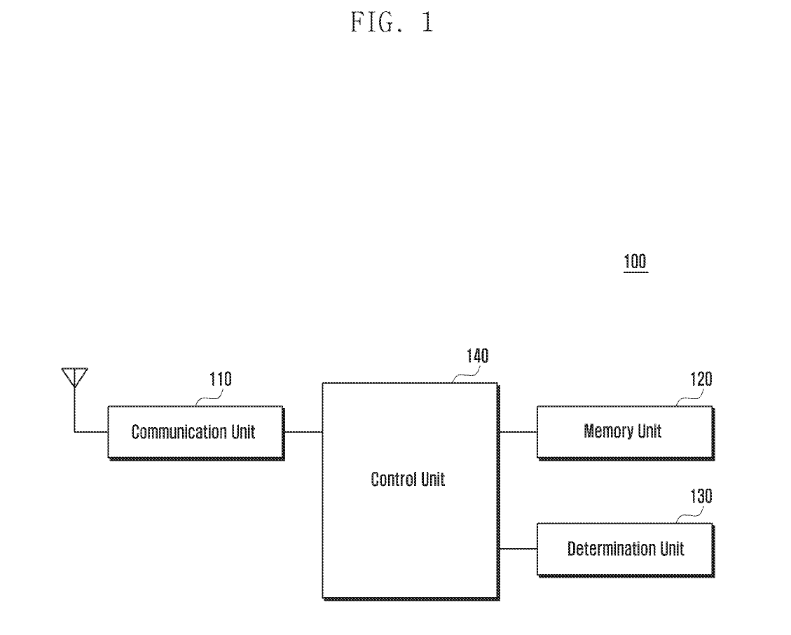

FIG. 1 is a block diagram illustrating an internal structure of a playlist providing apparatus according to an embodiment of the present disclosure.

Referring to FIG. 1, the playlist providing apparatus 100 may include, but not limited to, a communication unit 110, a memory unit 120, a determination unit 130, and a control unit 140.

The communication unit 110 performs a function to transmit and receive data for access to a content server. Also, the communication unit 110 may receive a request for the playback of specific content from a terminal. When such a request is received, the communication unit 110 may receive a playlist containing information about at least one bandwidth available for the playback of specific content from the content server. Specifically, the playlist may contain at least one metadata that includes information about at least one bandwidth available for the playback of specific content. Such bandwidth information may include information about a transmission speed. Additionally, the communication unit 110 may transmit the playlist revised at the control unit 140 to the terminal. Further, in order to revise the playlist, the communication unit 110 may receive information about a network bandwidth from other network apparatus.

The memory unit 120 may store network bandwidth information received from the communication unit 110. Additionally or alternatively, the memory unit 120 may store network bandwidth information determined by the determination unit 130. Also, the memory unit 120 may store setting information used for revising a playlist received from the content server.

The determination unit 130 may compare bandwidth information, contained in the playlist received from the content server, with available bandwidth information of the network, thereby determining metadata that includes bandwidth information incapable of offering a service smoothly. Namely, the determination unit 130 may compare the size of bandwidth information to determine such metadata. Additionally or alternatively, based on a predefined criterion, the determination unit 130 may determine such metadata.

The control unit 140 controls the whole operation of the playlist providing apparatus 100 according to an embodiment of this disclosure. Particularly, the control unit 140 may revise the playlist received from the server, based on an available bandwidth of the network.

Specifically, when the playlist is received from the content server, the determination unit 130 may determine bandwidth information incapable of offering a service smoothly from among bandwidth information contained in metadata of the playlist and transmit the determined information to the control unit 140. Then, based on such information received from the determination unit 130, the control unit 140 may revise the playlist.

For example, the control unit 140 may control the playlist to be revised by deleting metadata containing bandwidth information incapable of offering a service smoothly. Also, the control unit 140 may control such metadata to be inactivated. And also, the control unit 140 may control metadata, containing bandwidth information capable of offering a service smoothly, to be selectively displayed.

Additionally, the control unit 140 may convert metadata contained in the playlist so that a user can easily perceive information about the metadata.

Additionally, the control unit 140 may determine the bandwidth of the network.

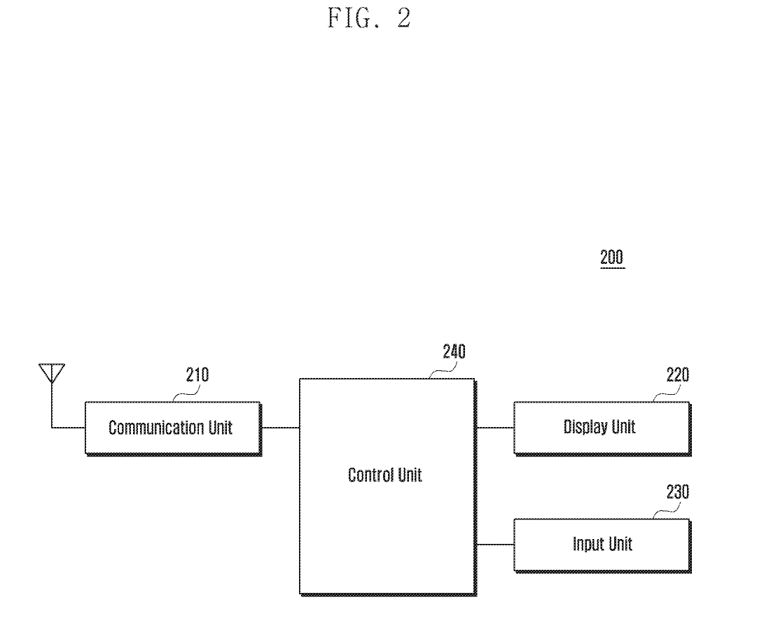

FIG. 2 is a block diagram illustrating an internal structure of a terminal according to an embodiment of the present disclosure.

Referring to FIG. 2, the terminal 200 may include a communication unit 210, a display unit 220, an input unit 230, and a control unit 240. The terminal 200 may include an electronic device such as a smart phone, a personal computer (PC), a tablet PC, and the like.

The communication unit 210 may transmit a request for playback of content to the content server. Alternatively, the communication unit 210 may transmit a request for playback of content to a playlist providing apparatus. Additionally, the communication unit 210 may receive a playlist from the content server or the playlist providing apparatus. The playlist received from the playlist providing apparatus may include the playlist received from the content server. Also, the playlist received from the playlist providing apparatus may include the playlist revised by the playlist providing apparatus.

The display unit 220 may be formed of liquid crystal display (LCD), organic light emitting diodes (OLED), and the like. In case a touch screen is used, the display unit 220, also referred to as a display panel, may be combined with a touch panel or a touch film The display unit 220 may visually offer, to a user, metadata contained in the received playlist.

For example, with regard to the same content, metadata of low quality, metadata of medium quality, and metadata of high quality may be offered. Each metadata may contain bandwidth information required for playback of content. Metadata contained in the playlist may be visually offered to a user through the display unit 220 in the form of an icon or any other graphic element for user's easy perception.

The input unit 230 may receive a user's manipulation for selecting one of metadata contained in the received playlist, create a corresponding input signal, and deliver the created input signal to the control unit 240.

If the revised playlist is received, the control unit 240 may transmit information about metadata selected by a user input to the playlist providing apparatus. Also, if setting information for selecting one of metadata contained in the playlist is stored, the control unit 240 may transmit information about one of metadata to the playlist providing apparatus according to the setting information.

Additionally, the control unit 240 may convert metadata contained in the received playlist into visual information so as to visually offer such metadata to a user through the display unit 220.

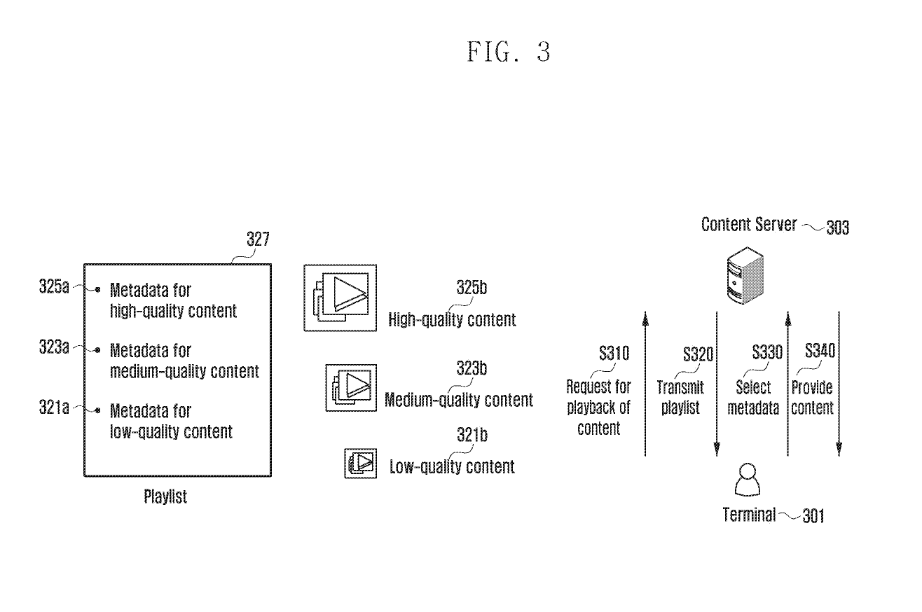

FIG. 3 is a diagram illustrating a method for providing contents to a terminal through a content server according to an embodiment of the present disclosure.

Referring to FIG. 3, at operation S310, the terminal 301 transmits a playback request message for content to the content server 303. At operation S320, the content server 303 that receives the playback request message may transmit a playlist 327 corresponding to such a request to the terminal 301.

In this disclosure, the playlist 327 may refer to a list of metadata containing information about at least one bandwidth available for content.

For example, the playlist 327 may include metadata 321a for low-quality content, metadata 323a for medium-quality content, and metadata 325a for high-quality content. Such metadata may be offered visually to a user. For example, icons corresponding to low-quality content 321b, medium-quality content 323b, and high-quality content 325b may have different sizes.

The metadata contained in the playlist 327 may have bandwidth information required for playback of content. For example, bandwidth of 5 Mbps may be needed to play high-quality content, and this information may be contained in the metadata.

The terminal 301 receiving the playlist at operation S320 may select, at operation S330, one of metadata contained in the playlist. Additionally, the terminal 301 may transmit information about the selected metadata to the content server 303. Selection of metadata may depend on a user input. Alternatively, setting information for selecting metadata may be stored in advance in the terminal 301. For example, the setting information may indicate that metadata having the greatest bandwidth will be selected when the terminal receives metadata.

The content server 303 receiving information about the selected metadata at operation S330 may offer, at operation S340, content corresponding to the selected metadata to the terminal 301.

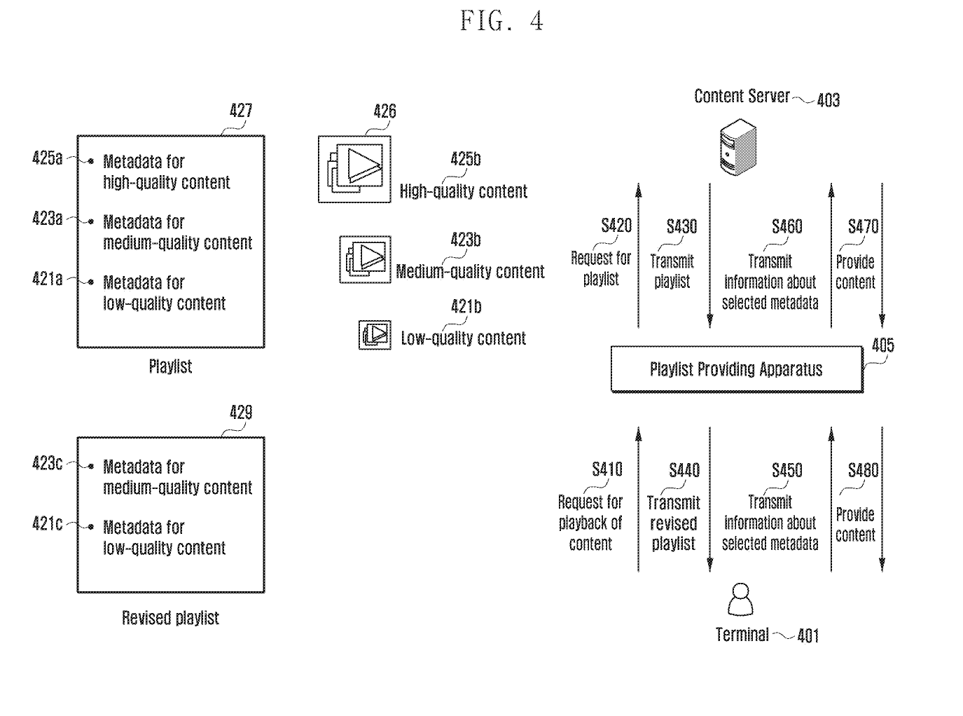

FIG. 4 is a diagram illustrating a method for providing contents to a terminal through a playlist providing apparatus according to an embodiment of the present disclosure.

Referring to FIG. 4, in an embodiment, the playlist providing apparatus 405 may revise a playlist received from the content server 403, based on an available bandwidth of the network. The playlist providing apparatus 405 may be installed in the form of software or hardware in a network entity located on a transmission path of playlist.

At operation S410, the terminal 401 may transmit a playback request message for content to the playlist providing apparatus 405. Then, at operation S420, the playlist providing apparatus 405 may send a request for a playlist about the content to the content server 403.

The content server 403 that receives the request from the playlist providing apparatus 405 may transmit, at operation S430, the playlist 427 containing information about at least one available bandwidth for the content requested by the terminal 401 to the playlist providing apparatus 405.

As mentioned above, the playlist 427 may refer to a list of metadata containing information about at least one bandwidth available for the content requested by the terminal 401.

The metadata may include bandwidth information required for playing content.

For example, when a user accesses a web site to watch a baseball broadcast, the terminal may send a request for a baseball broadcast service to the playlist providing apparatus and then the playlist providing apparatus may request a playlist about a baseball broadcast from the content server. In response to such a request, the content server may offer a baseball broadcast streaming service to the terminal. At this time, the content server may offer low-quality content 421b, medium-quality content 423b, and high-quality content 425b with regard to the same content. In this case, information about such contents may be contained in metadata, and the content server may insert a list of such metadata into a playlist and then transmit the playlist to the playlist providing apparatus.

The playlist 427 is an example of a playlist transmitted to the playlist providing apparatus by the content server. The playlist 427 may include metadata for low-quality content (hereinafter, low-quality metadata 421a), metadata for medium-quality content (hereinafter, medium-quality content 423a), and metadata for high-quality content (hereinafter, high-quality content 425a).

Additionally, in order to offer such content having a low quality, medium quality or high quality, a corresponding specific bandwidth is required. Therefore, metadata for specific content (e.g., low-quality content) may contain corresponding bandwidth information (e.g., low-quality bandwidth information) to offer a suitable service for that content.

The playlist providing apparatus 405 that receives the playlist may compare bandwidth information contained in the metadata with an available bandwidth of the network and then revise the received playlist. Specifically, if a bandwidth contained in the metadata is greater than an available bandwidth of the network, the playlist providing apparatus 405 may delete the metadata.

For example, suppose that a currently available bandwidth of the network is 3 Mbps. Further, suppose that bandwidths of 5 Mbps, 1 Mbps, and 500 Kbps are required respectively for offering services for high-quality, medium-quality, and low-quality contents. In this case, since a bandwidth required for offering a high-quality streaming service is greater than an available bandwidth of the network, the high-quality streaming service cannot be offered smoothly. Therefore, the playlist providing apparatus 405 may delete high-quality metadata.

The playlist 429 is an example of a playlist revised by the playlist providing apparatus. As shown, high-quality metadata is removed from the revised playlist 429, leaving medium-quality metadata 423c and low-quality metadata 421c.

After revising the playlist as discussed above, the playlist providing apparatus transmits the revised playlist to the terminal at operation S440.

At operation S440, metadata may be contained in the playlist transmitted to the terminal, and the playlist providing apparatus may convert information about the metadata contained in the playlist into an easily perceivable form to a user. For example, the playlist providing apparatus may convert the metadata into the form of an icon 426.

The terminal 401 that receives the revised playlist may select one of the metadata contained in the revised playlist and then transmit the selected metadata to the playlist providing apparatus 405 at operation S450. Then, at operation S460, the playlist providing apparatus 405 may transmit information about the selected metadata to the content server 403.

After information about the selected metadata is received, the content server 403 may transmit specific content corresponding to the selected metadata to the playlist providing apparatus 405 at operation S470, and the playlist providing apparatus 405 may transmit the received content to the terminal at operation S480.

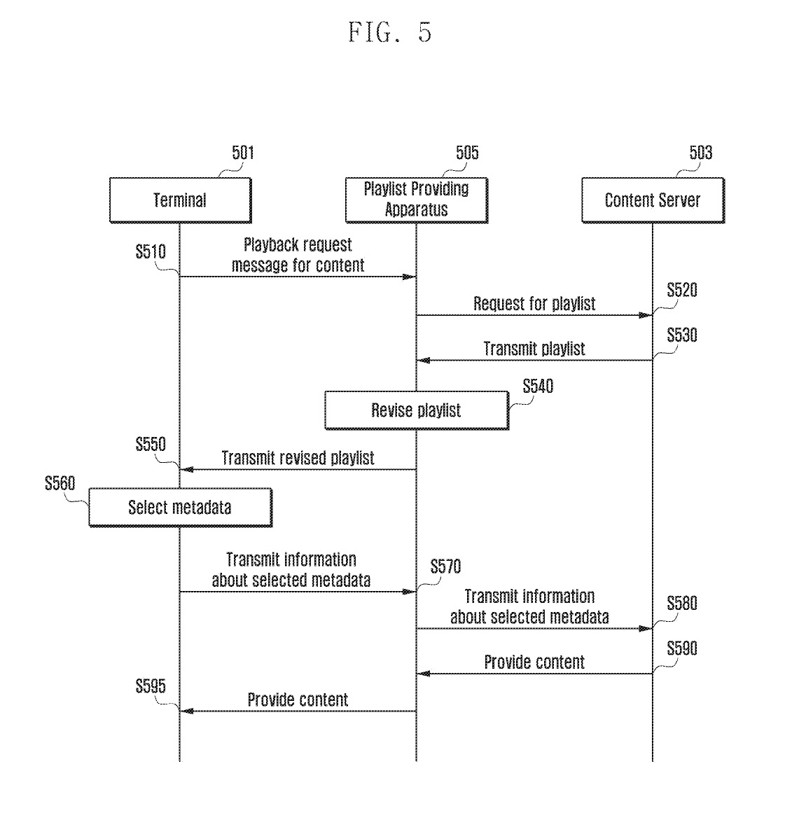

FIG. 5 is a flow diagram illustrating a method for providing contents to a terminal through a playlist providing apparatus according to an embodiment of the present disclosure.

Referring to FIG. 5, at operation S510, the terminal 501 may transmit a playback request message for specific content to the playlist providing apparatus 505. Then, at operation S520, the playlist providing apparatus 505 may request a playlist from the content server 503.

At operation S530, the content server 503 that receives a request for playlist may transmit, to the playlist providing apparatus 505, a playlist containing information about at least one available bandwidth for requested content. Since the playlist is discussed above, a detailed description thereof will be omitted herein.

At operation S540, the playlist providing apparatus 505 that receives the playlist may revise the received playlist by comparing a bandwidth contained in metadata of the received playlist with an available bandwidth of the network. For example, if a bandwidth contained in the metadata is greater than an available bandwidth of the network, the playlist providing apparatus may delete the metadata. Since this is discussed previously in FIG. 4, a detailed description thereof will be omitted herein.

After revising the playlist, the playlist providing apparatus 505 may transmit the revised playlist to the terminal 501 at operation S550.

At operation S560, the terminal 501 that receives the revised playlist may select one of metadata contained in the received playlist. Selection of metadata may depend on a user input. Alternatively, setting information for selecting metadata may be stored in advance in the terminal. For example, the setting information may indicate that metadata having the greatest bandwidth will be selected when the terminal receives metadata.

After the metadata is selected, the terminal 501 may transmit information about the selected metadata to the playlist providing apparatus 505 at operation S570. Also, the playlist providing apparatus 505 may transmit the received information to the content server 503 at operation S580.

The content server 503 that receives the information about the selected metadata may transmit specific content corresponding to the selected metadata to the playlist providing apparatus 505 at operation S590, and the playlist providing apparatus 505 may transmit the content to the terminal 501 at operation S595.

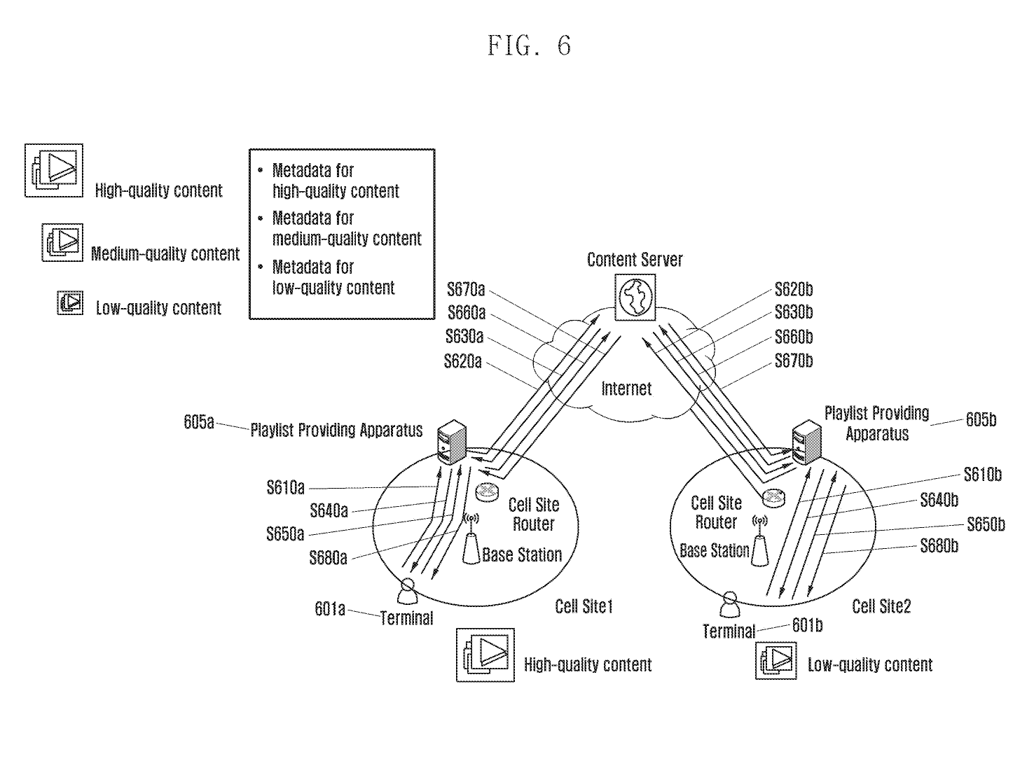

FIG. 6 is a diagram illustrating a detailed method for providing contents to a terminal through a playlist providing apparatus according to an embodiment of the present disclosure.

Referring to FIG. 6, it is supposed that a cell site 1 is a region having a sufficient bandwidth of the network and another cell site 2 is a region having a relatively insufficient bandwidth of the network.

The terminal 601a located in the cell site 1 may transmit a playback request message for specific content to the playlist providing apparatus 605a at operation S610a. Then, at operation S620a, the playlist providing apparatus 605a that receives the message may request a playlist from the content server 603.

As mentioned above, the playlist providing apparatus 605a may be installed in the form of software or hardware in a network entity located on a transmission path of playlist. For example, the network entity may include a base station, a core gateway, a cell site router, a server located in the cell site, and the like. FIG. 6 shows, for example, that the playlist providing apparatus is installed in a server located in the cell site.

At operation S630a, the content server 603 that receives a request for playlist may transmit, to the playlist providing apparatus 605a, a playlist including information about at least one available bandwidth for specific content requested by the terminal 601a.

The playlist providing apparatus 605a that receives the playlist may revise the received playlist by comparing a bandwidth contained in metadata of the received playlist with an available bandwidth of the network as discussed above at operation S540.

At this time, the playlist providing apparatus 605a may determine an available bandwidth of the network. Alternatively, the playlist providing apparatus 605a may receive an available bandwidth of the network from a certain network entity. Such an available bandwidth of the network may include a transmission speed (bit/sec), a bandwidth level, a bandwidth load, and/or any other information.

If it is determined that a network bandwidth is sufficient, the playlist providing apparatus 605a needs not revise the playlist and transmits the playlist, received from the content server 603, to the terminal 601a at operation S640a.

At operation S650a, the terminal 601a that receives the playlist may select one of metadata contained in the received playlist and transmit information about the selected metadata to the playlist providing apparatus 605a. Then, at operation S660a, the playlist providing apparatus 605a may transmit the received information to the content server 603.

At operations S670a and S680a, the content server may transmit specific content corresponding to the selected metadata to the terminal through the playlist providing apparatus. Since the cell site 1 has a sufficient available bandwidth of the network, it is possible to offer high-quality content.

In case the terminal 601b located in the cell site 2 transmits a playback request message for specific content, the playlist providing apparatus 605b may receive a playlist through operations 610b to 630b, which are equal to the above-discussed operations 610a to 630a.

The playlist providing apparatus 605b that receives the playlist from the content server 603 at operation S630b revises the received playlist by comparing a bandwidth contained in metadata of the received playlist with an available bandwidth of the network.

As discussed above, a method for revising the playlist may include comparing sizes of bandwidths and, if a bandwidth contained in the metadata is greater in size than an available bandwidth of the network, deleting the metadata.

Alternatively, the method for revising the playlist may include comparing sizes of bandwidths and, if a bandwidth contained in the metadata is greater in size than an available bandwidth of the network, inactivating the metadata.

Alternatively, the playlist providing apparatus may store setting information to be used for revising the playlist. For example, in consideration of network load, this setting information may indicate that the metadata will be deleted or inactivated when a bandwidth contained in the metadata exceeds 70% of an available bandwidth of the network.

In case of revising the playlist, the playlist providing apparatus 605b may transmit the revised playlist to the terminal 601b at operation S640b.

The terminal 60 lb may receive specific content corresponding to desired metadata through operations 650b to 680b, which are equal to the above-discussed operations 650a to 680a.

In an embodiment as shown in FIG. 6, the terminal 601b located in the cell site 2 may receive low-quality content.

If the terminal 601a located in the cell site 1 moves to the cell site 2 while receiving high-quality content, the terminal may fail to receive the high-quality content any more.

In this case, the playlist providing apparatus 605b located in the cell site 2 having an insufficient available bandwidth of the network may stop to offer high-quality content to the terminal and transmit the revised playlist to the terminal.

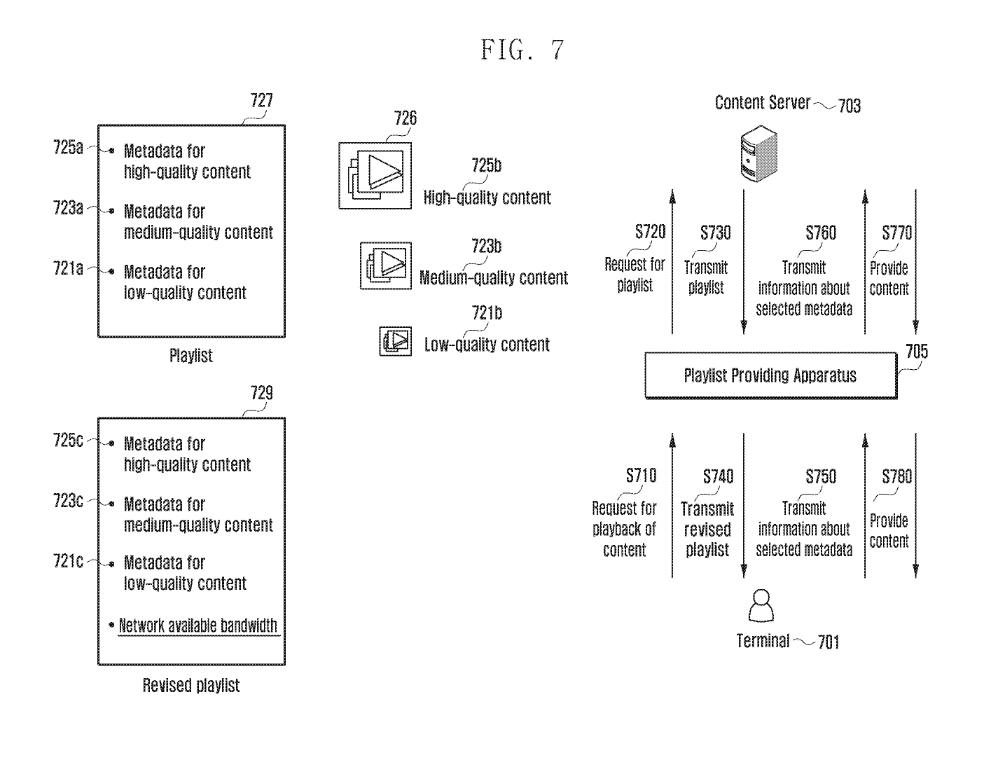

FIG. 7 is a diagram illustrating a method for providing contents to a terminal through a playlist providing apparatus according to an embodiment of the present disclosure.

Referring to FIG. 7, operations S710 to S730 are equal to the above-discussed operations S410 to S430 in FIG. 4.

Except as otherwise detailed below, icon 726, playlist 727, revised playlist 729, low-quality metadata 721a and 721c, medium-quality metadata 723a and 723c, high-quality metadata 725a and 725c, low-quality content 721b, medium -quality content 723b, and high quality content 725b are the same as described above with regard to FIG. 4, and a description thereof will not be repeated.

The playlist providing apparatus 705 that receives a playlist from the content server 703 at operation S730 may revise the received playlist, based on an available bandwidth of the network.

This embodiment proposes another method for revising the playlist at the playlist providing apparatus 705.

Specifically, in this embodiment, the playlist providing apparatus 705 may add information about an available network bandwidth to the playlist 727.

Thereafter, the playlist providing apparatus 705 may transmit the revised playlist 729 to the terminal 701 at operation S740.

Based on the revised playlist 729 having added information about an available network bandwidth, a user can select specific content suitable for a current network state. Alternatively, setting information for selecting metadata suitable for a network state may be stored in advance in the terminal. For example, this setting information may indicate that metadata having the greatest bandwidth will be selected from among all metadata having bandwidths smaller than an available network bandwidth.

After the terminal selects the metadata by using the revised playlist, the terminal may receive specific content corresponding to the selected metadata through operations S750 to S780, which are equal to the above-discussed operations S450 to S480 in FIG. 4.

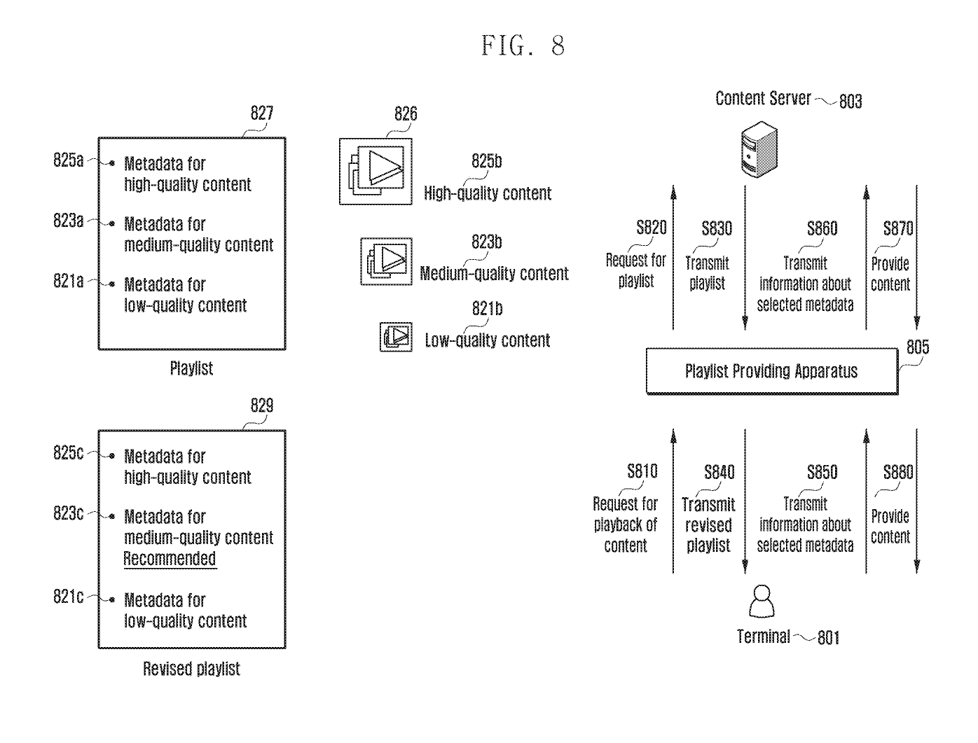

FIG. 8 is a diagram illustrating a method for providing contents to a terminal through a playlist providing apparatus according to an embodiment of the present disclosure.

Except as otherwise detailed below, icon 826, playlist 827, revised playlist 829, low-quality metadata 821a and 821c, medium-quality metadata 823a and 823c, high-quality metadata 825a and 825c, low-quality content 821b, medium -quality content 823b, and high quality content 825b are the same as described above with regard to FIG. 4, and a description thereof will not be repeated.

Referring to FIG. 8, operations S810 to S830 are equal to the above-discussed operations S410 to S430 in FIG. 4.

The playlist providing apparatus 805 that receives a playlist from the content server 803 at operation S830 may revise the received playlist, based on an available bandwidth of the network.

This embodiment proposes still another method for revising the playlist at the playlist providing apparatus 805.

Specifically, in this embodiment, the playlist providing apparatus 805 may select and display one metadata, based on an available network bandwidth.

Also, setting information to be used for selecting the metadata may be stored in the playlist providing apparatus 805. This setting information may indicate that metadata having bandwidth information which does not exceed an available network bandwidth will be selected.

For example, if it is impossible to offer a service for high-quality content to the terminal at a current available network bandwidth, the playlist providing apparatus 805 may select and display medium-quality metadata.

A method for displaying the selected metadata may include varying the size of an icon displayed on the terminal. Also, this method may include displaying recommended metadata as shown in the revised playlist 829. And also, various techniques may be used for highlighting the metadata.

Through such a display, a user of the terminal may find specific metadata suitable for the most smooth playback in a current network state.

At operation S840, the playlist providing apparatus 805 may transmit the revised playlist 829 to the terminal 801, and then the terminal may select one of the metadata contained in the revised playlist.

After specific metadata is selected using the revised playlist, the terminal may receive specific content corresponding to the selected metadata through operations S850 to S880, which are equal to the above-discussed operations S450 to S480 in FIG. 4.

According to this disclosure, even though an available bandwidth of the network is insufficient, the terminal may receive a desired service smoothly by receiving a revised playlist and then requesting a corresponding service. Further, this may reduce any undesirable load of the network.

While the present disclosure has been shown and described with reference to various embodiment thereof, it will be understood by those skilled in the art that various changes in form and details may be made therein without departing from the spirit and scope of the present disclosure as defined by the appended claims and their equivalents.

What is claimed is:

1. An apparatus for providing a playlist, the apparatus comprising:
a communication unit configured to perform communication with another network entity; and
a control unit configured to:
receive a playback request message for content from a terminal through the communication unit,
transmit a request for a playlist including information of at least one bandwidth capable of playing the content to a server through the communication unit,
receive the playlist from the server through the communication unit,
revise the received playlist based on information of an available network bandwidth, and
transmit the revised playlist to the terminal through the communication unit.

2. The apparatus of claim 1, wherein the control unit is further configured to delete, from the playlist, information related to a bandwidth that exceeds the available network bandwidth.

3. The apparatus of claim 1, wherein the control unit is further configured to add the information of the available network bandwidth to the playlist.

4. The apparatus of claim 1, wherein the control unit is further configured to:
select a specific one of bandwidths included in the playlist, and
control to display information of the selected specific one bandwidth.

5. The apparatus of claim 4, wherein the control unit is further configured to select the specific one bandwidth, based on the information of the available network bandwidth.

6. The apparatus of claim 1, wherein the apparatus is installed in one of network entities located on a transmission path of the playlist.

7. The apparatus of claim 1, wherein the information of the available network bandwidth includes at least one of a transmission speed, a bandwidth level, and a bandwidth load.

8. A terminal for receiving a playlist, the terminal comprising:
a communication unit configured to perform communication with another network entity; and
a control unit configured to:
control the communication unit to transmit a playback request message for content to a playlist providing apparatus, and
control the communication unit to receive a revised playlist from the playlist providing apparatus,
wherein the revised playlist is based on a playlist including information of at least one bandwidth capable of playing the content, according to information of an available network bandwidth.

9. The terminal of claim 8, wherein the control unit is further configured to control the communication unit to receive the revised playlist from which information related to a bandwidth that exceeds the available network bandwidth is deleted.

10. The terminal of claim 8, wherein the control unit is further configured to control the communication unit to receive the revised playlist to which the information of the available network bandwidth is added.

11. The terminal of claim 8, wherein the control unit is further configured to control the communication unit to receive the revised playlist in which information of a selected one of the at least one bandwidth is displayed.

12. The terminal of claim 11, wherein the displayed bandwidth information is selected, based on the information of the available network bandwidth.

13. The terminal of claim 8, wherein the playlist providing apparatus is installed in one of network entities located on a transmission path of the playlist.

14. The terminal of claim 8, wherein the information of the available network bandwidth includes at least one of a transmission speed, a bandwidth level, and a bandwidth load.

15. A method for providing a playlist at a playlist providing apparatus in a network, the method comprising:
receiving, from a terminal, a playback request message for content;
transmitting, to a server, a request for a playlist including information of at least one bandwidth capable of playing the content;
receiving, from the server, the playlist;
revising, based on information of an available network bandwidth, the received playlist; and
transmitting, to the terminal, the revised playlist.

16. The method of claim 15, wherein the revising includes deleting, from the playlist, information related to a bandwidth that exceeds the available network bandwidth.

17. The method of claim 15, wherein the revising includes adding the information of the available network bandwidth to the playlist.

18. The method of claim 15, wherein the revising includes selecting a specific one of bandwidths included in the playlist and displaying information of the selected specific one bandwidth.

19. The method of claim 18, wherein the specific one bandwidth is selected based on the information of the available network bandwidth.

20. The method of claim 15, wherein the playlist providing apparatus is installed in one of network entities located on a transmission path of the playlist.

21. The method of claim 15, wherein the information of the available network bandwidth includes at least one of a transmission speed, a bandwidth level, and a bandwidth load.

22. A method for receiving a playlist at a terminal in a network, the method comprising:
transmitting a playback request message for content to a playlist providing apparatus; and
receiving a revised playlist from the playlist providing apparatus,
wherein the revised playlist is based on a playlist including information of at least one bandwidth capable of playing the content, according to information of an available network bandwidth.

23. The method of claim 22, wherein the receiving includes receiving the revised playlist from which information related to a bandwidth that exceeds the available network bandwidth is deleted.

24. The method of claim 22, wherein the receiving includes receiving the revised playlist to which the information of the available network bandwidth is added.

25. The method of claim 22, wherein the receiving includes receiving the revised playlist in which information of a selected one of the at least one bandwidth is displayed.

26. The method of claim 25, wherein the displayed bandwidth information is selected based on the information of the available network bandwidth.

27. The method of claim 22, wherein the playlist providing apparatus is installed in one of network entities located on a transmission path of the playlist.

28. The method of claim 22, wherein the information of the available network bandwidth includes at least one of a transmission speed, a bandwidth level, and a bandwidth load.
